(19) United States
(12) Patent Application Publication
(10) Pub. No.: US 2007/0230780 A1
(43) Pub. Date: Oct. 4, 2007

(54) Hue correction system and method thereof

(76) Inventors: Hung-Shing Chen, Hsin-chu (TW); Te-Mei Wang, Hsin-chu (TW); Shih-Han Chen, Hsin-Chu (TW); Jin-Sin Liu, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/723,784

(22) Filed: Mar. 22, 2007

(30) Foreign Application Priority Data
Apr. 4, 2006 (TW) 095111994

(51) Int. Cl. G06K 9/00

(52) U.S. Cl. 382/167

(57) ABSTRACT

A hue correction system and a method thereof are disclosed. The hue correction system includes a segmentation unit, a processing unit, and a correction unit. The segmentation unit segments the color gamut of a color output device and a reference device respectively into a plurality of source hue pages and a plurality of reference hue pages. Or only the color gamut of the color output device is segmented into a plurality of source hue pages and a plurality of reference hue pages. The source hue pages and the reference hue pages correspond to each other. Then, the processing unit gets a plurality of hue page conversion factors from the above mentioned hue pages. At last, the correction unit corrects an input color data being input to the color output device according to the source hue pages and the hue page conversion factors.

### BACKGROUND OF THE INVENTION

The present invention relates to a correction system and a method thereof, especially to a hue correction system and a method thereof that improve color rendering of color output devices.

Different color output devices have different color gamut. There are several methods to process the color gamut mapping among different devices. Sometimes, it is not necessary to map the whole color gamut from one device to another. Only part of the colors are processed and corrected to the desired colors.

Colors are defined by three visual attributions - lightness, chroma, and hue. Hue is the basic attribute we distinguish colors from one another. Thus, most color correction methods focus on the hue correction. For example, refer to U.S. Pat. No. 5,953,499, the HSV (hue, saturation, value) color space data is applied to a rotated lookup table for selectively rotating hue angles of color data. This method has good hue correction results, however, it can't flexibly correct hue, chroma and lightness to provide complex color corrections for some devices. Use wide-color-gamut LCD display as an example, we may need to do several different color corrections to make it more pleasing to users; for some memory colors and trade mark colors, we may need to correct their hue, chroma, and lightness *s pre-defined colors; for some green colors, we may need to correct their hue and extend their chroma; but for some out-of-gamut blue colors, we may need to shrink their chroma and map it into the color gamut of LCD display.

The present invention provides a hue correction system and a method thereof that provides flexible hue correction together with appropriate chroma and lightness corrections to accommodate complex color correction requirements.

### SUMMARY OF THE INVENTION

A hue correction system according to the present invention includes a segmentation unit, a processing unit, and a correction unit. A hue correction method according to the present invention consists of the following steps: firstly, according to a plurality of color characteristic data of a color output device and a reference device, segment color gamut of the color output device and color gamut of the reference device into a plurality of source hue pages and a plurality of reference hue pages respectively by the segmentation unit. The source hue pages and the reference hue pages correspond to each other. Then the processing unit gets a plurality of hue page conversion factors according to the source hue pages and the reference hue pages that correspond to each other. Each of hue page conversion factor corresponds to a set of a source hue page and a reference hue page that corresponds to each other. At last, the correction unit corrects an input color data being input into the color output device according to the source hue pages and the hue page conversion factors. Therefore, complex color correction is achieved and further color quality of the color output device is improved.

Moreover, the hue correction method according to the present invention can also only segment color gamut of the color output device into a plurality of source hue pages and a plurality of reference hue pages according to a plurality of color characteristic data of the color output device and the reference device. Then the processing unit gets a plurality of hue page conversion factors according to the source hue pages and the reference hue pages that correspond to each other. Finally, the correction unit corrects the input color data according to the source hue pages and the hue page conversion factors.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of an embodiment according to the present invention;

FIG. 2 is a coordinate showing locations of hue pages according to the present invention;

FIG. 3A is a schematic drawing showing how a processing unit of an embodiment according to the present invention gets a hue page conversion factor;

FIG. 3B is a schematic drawing showing how a processing unit of another embodiment according to the present invention gets a hue page conversion factor;

FIG. 3C is a schematic drawing showing how a processing unit of a further embodiment according to the present invention gets a hue page conversion factor;

FIG. 4 is a schematic drawing showing how a correction unit of an embodiment according to the present invention corrects input color data;

FIG. 5 is a flow chart of an embodiment in accordance with the present invention;

FIG. 6 is a flow chart of another embodiment in accordance with the present invention;

FIG. 7 is a block diagram of another embodiment according to the present invention; and

FIG. 8 is a flow chart of a further embodiment in accordance with the present invention.

### DETAILED DESCRIPTION OF THE PREFERRED EMBODIMENT

The way for hue correction of the present invention uses reference colors to correct colors represented on the color output device so as to improve the color quality of the color output device. For correcting the color output device, firstly input test color data into the reference device and the color output device. And color characteristics are learned by means of measuring instrument that measures the represented colors. Thus color characteristic data of the reference device and the color output device are got. The color output device and the reference device include monitors, projectors, or color printers.

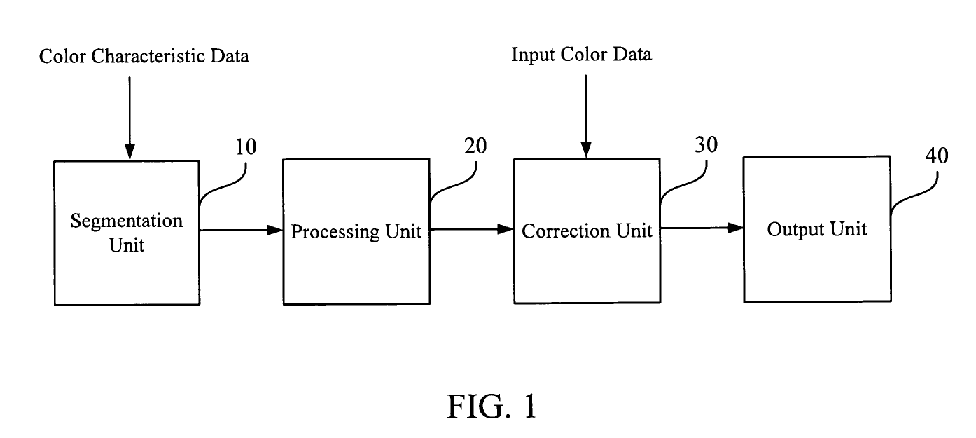

Refer to FIG. 1, the present invention composed of a segmentation unit 10, a processing unit 20, a correction unit 30 and an output unit 40 is disposed on a color output device. The segmentation unit 10 receives color characteristic data from the color output device and from the reference device. Then according to color characteristic data of these two devices, segment color gamut of these two devices into a plurality of source hue pages and a plurality of reference hue pages. The source hue pages and the reference hue pages correspond to each other.

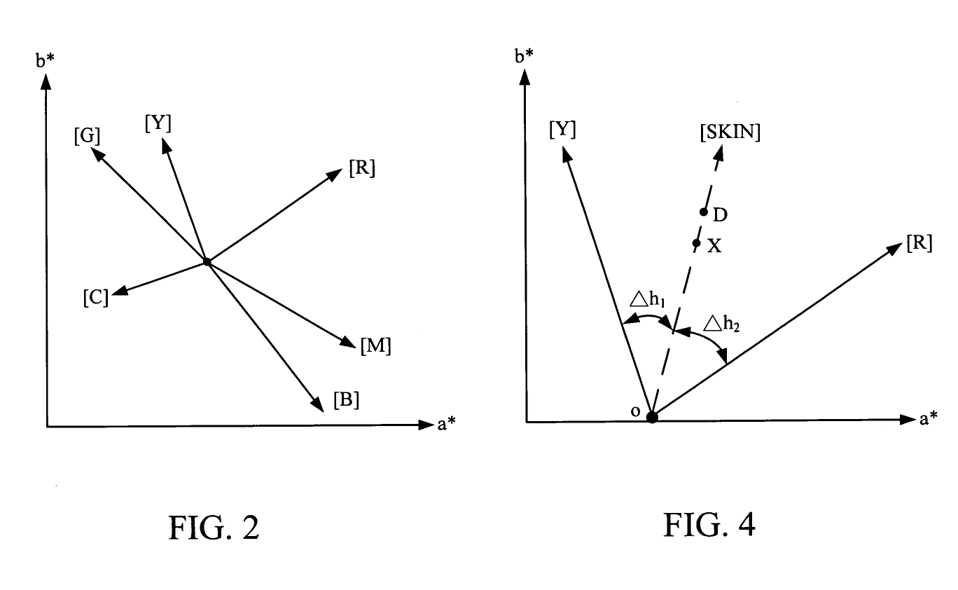

In an embodiment of the present invention, the color gamut is segmented into six hue pages, as shown in FIG. 2, red (R), yellow (Y), green (G), cyan (C), blue (B) and magenta (M). The more hue pages the color gamut is segmented into, the better the effect of color correction is.

The processing unit 20 receives hue pages segmented by the segmentation unit 10 and then calculates the data of the source hue page and the reference hue page that correspond to each other to obtain a hue page conversion factor. The hue page conversion factor is a factor necessary for conversion of the source hue page into the reference hue page. For example, according to a first source hue page (R) of the color output device and a first reference hue page (R) of the reference device, the processing unit 20 calculates to get a conversion factor that corresponds to the first source hue page. Thus if color gamut of the color output device and the reference device are respectively segmented into six hue pages by the segmentation unit 10, the processing unit 20 generates six conversion factors of the hue pages through operation. Each source hue page has a corresponding hue page conversion factor. The hue page conversion factor is a n×m matrix, both n and m are no less than 3.

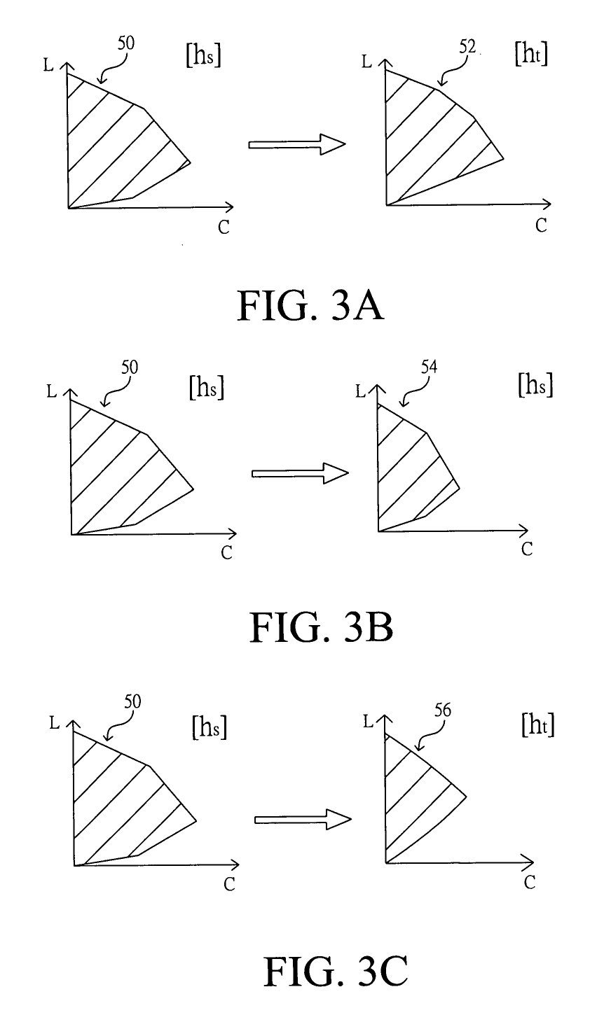

The processing unit 20 of the present invention has three ways to get the hue page conversion factor. The first way is to correct the hue angle. As shown in FIG. 3A, the hue angle of the source hue page 50 is hₛ while the hue angle of the corresponding reference hue page 52 is hₜ, the processing unit 20 operates to get the hue page conversion factor that corrects the hue angle hₛ of the source hue page 50 to the hue angle hₜ of the reference hue page 52.

The second way to get the hue page conversion factor is to correct area size of hue page. As shown in FIG. 3B, the hue angle of the source hue page 50 is hₛ while the corresponding reference hue page 54 has the same hue angle hₛ with different area size. The processing unit 20 calculates data to get a hue page conversion factor that corrects the area size of the source hue page 50 to the area size of the reference hue page 54. Such correction also properly corrects the lightness and chroma of the source hue page.

The third way to get the hue page conversion factor is to correct hue angle and area size of hue page. As shown in FIG. 3C, the hue angle of the source hue page 50 is hₛ while the hue angle of the corresponding reference hue page 56 is hₜ. The processing unit 20 calculates data to get a hue page conversion factor that corrects the hue angle hₛ as well as area size of the source hue page 50 to the hue angle hₜ as well as area size of the reference hue page 56.

Moreover, the segmentation unit 10 of the present invention can choose not to segment color gamut of the reference device into a plurality of reference hue pages while it segments color gamut of the color output device into a plurality of reference hue pages according to color characteristic data of the reference device for replacing reference hue pages of the reference device. The hue angle of the reference hue page of the color output device is the same with the hue angle of the reference hue page it replaces. In the color output device, the source hue page corresponds to the reference hue page. In this embodiment, the processing unit 20 gets the hue page conversion factors, not depending on the reference hue pages of the reference device, it's according to the reference hue page of the color output device.

For example, if the hue angle of the source hue page is hₛ while the hue angle of the corresponding reference hue page is hₜ, the processing unit 20 calculates data to get a hue page conversion factor that corrects the hue angle hₛ of the source hue page into the hue angle hₜ of the reference hue page 56.

Back to FIG. 1, the correction unit 30 receives an input color data being input into the color output device and then checks that the input color data is between which two neighboring source hue pages. Then it further gets a correction factor according to the hue page conversion factors of these two source hue pages. If the input color data is just located on a source hue page, the hue page conversion factor of that source hue page is used. At last, the correction unit 30 corrects the input color data according to the correction factor and transmits the corrected color data into the output unit 40 for display. Therefore, color represented by the color output device will identify with reference color intended to be present.

Refer to FIG. 4, the way that the correction unit 30 finds the input skin color data D is located between the red source hue page (R) and the yellow source hue page (Y). It is to compare the hue angle of the input color data D with the hue angle of each source hue page so as to get the location of the input color data D. Next, as the following equation (1) shows, correction factor M_{SKIN} of the input color data D is obtained according to the hue page conversion factor M_{R} of the red source hue page (R) and hue page conversion factor M_{Y} of the yellow source hue page (Y). Then according to the correction factor M_{SKIN}, use the equation (2) to calculate the corrected output color data X.

$$\begin{matrix}{M}_{SKIN} = ( \frac{Δ {h}_{1}}{Δ {h}_{1} + Δ {h}_{2}} ) {M}_{R} + ( \frac{Δ {h}_{2}}{Δ {h}_{1} + Δ {h}_{2}} ) {M}_{Y} & ( 1 ) \\ X = {M}_{SKIN} D & ( 2 )\end{matrix}$$

Moreover, refer to equation (1), it is learned that the correction factor is got according to the difference Δh₁, Δh₂ between the hue angle of input color data and the hue angles of two neighboring source hue pages. There are a lot of ways to get the correction factor, this is only an embodiment of the present invention. Furthermore, when an image is input into the color output device of the present invention, all input color data of the image is corrected by the correction unit 30 and then the corrected color data is transmitted to the output unit 40 to be displayed.

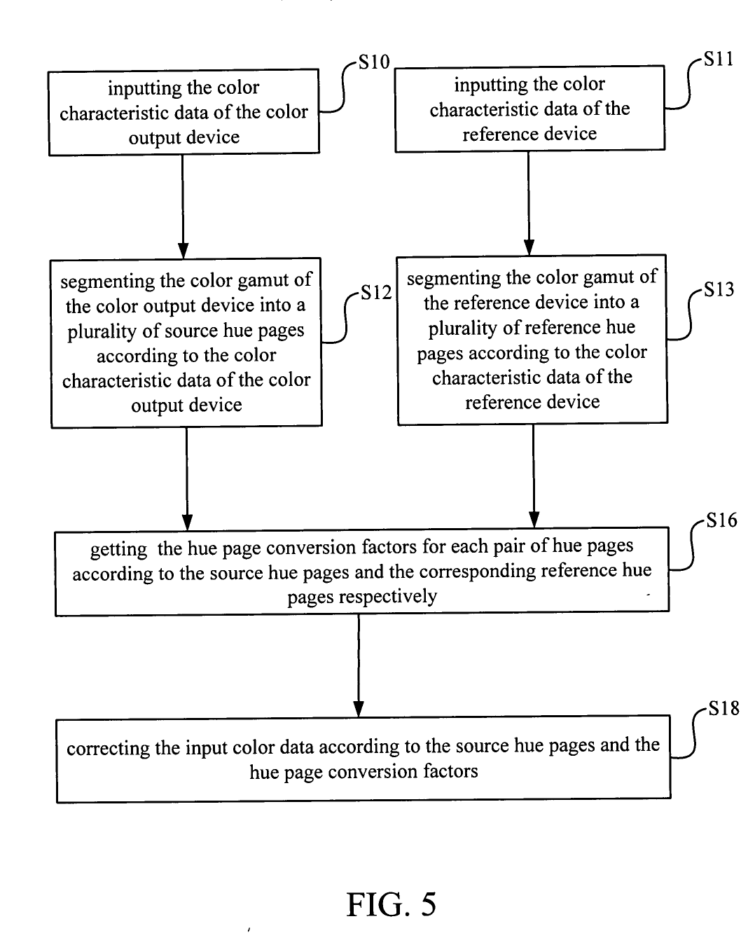

Refer to FIG. 5, a hue correction method according to the present invention includes the following steps: firstly see step S10 and S11, input the color characteristic data of the color output device and the reference device to the segmentation unit 10. Then, run step S12 and S13 by the segmentation unit 10 according to the color characteristic data of the color output device and the reference device, segment the color gamut of the color output device and the color gamut of the reference device into a plurality of source hue pages and a plurality of reference hue pages respectively. Take the step S16 by the processing unit 20, get a hue page conversion factor for each pair of hue pages according to the source hue pages and the reference hue pages that correspond to each other. When the input color data are sent to the color output device to be corrected, the correction unit 30 executes step S18, correct the input color data according to the source hue pages and the hue page conversion factors and send the corrected color data into the output unit 40 to be displayed. In this step, firstly checks the location of the input color data according to the hue angles and finds its two neighboring source hue pages. Then correct the input color data according to hue page conversion factors that is to get correction factor calculated from the hue page conversion factors of these two neighboring source hue pages and then correct the input color data according to the correction factor.

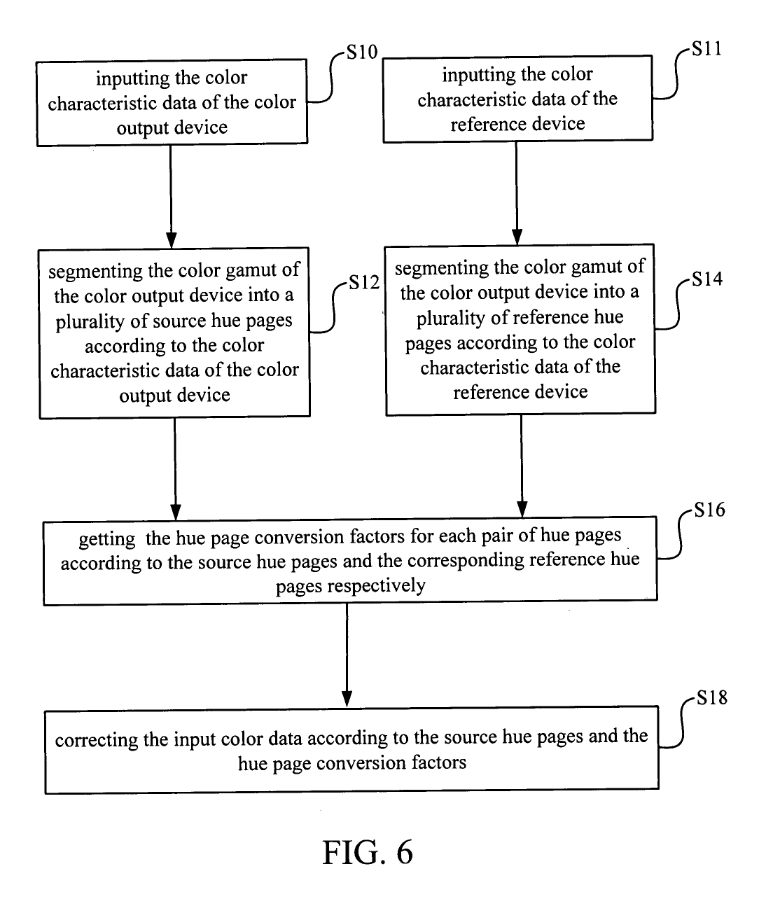

Refer to FIG. 6, the difference between this embodiment and the embodiment in FIG. 5 is in step S14 of this embodiment, segment the color gamut of the color output device into a plurality of reference hue pages according to the color characteristic data of the reference device while in the step S13 of FIG. 5, the color gamut of the reference device is segmented into a plurality of reference hue pages. After the segmentation unit 10 finishing the step S12 and S14, the processing unit 20 runs step S16, calculate to get a hue page conversion factor for each pair of hue pages according to the source hue page and the reference hue page that correspond to each other. At last, the correction unit 30 takes step S18, correct input color data according to the source hue pages and the hue page conversion factors and send the corrected color data into the output unit 40 for display.

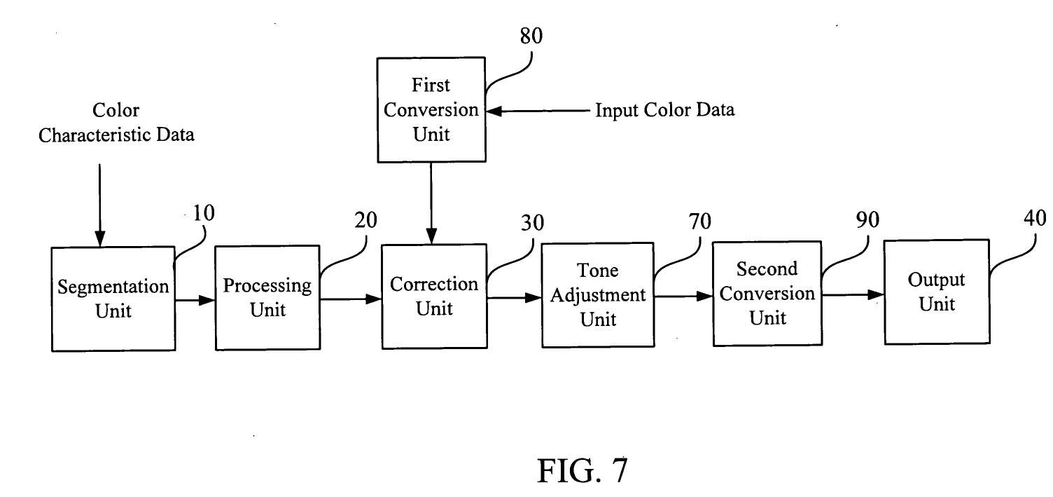

Refer to FIG. 7, the difference between this embodiment and the embodiment in FIG. 1 is in that this embodiment further includes a tone adjustment unit 70, a first conversion unit 80 and a second conversion unit 90. The tone adjustment unit 70 is used to adjust tone level of the color data corrected by the correction unit 30 so as to improve color quality of the color output device. Generally, common input color data is in RGB format. For convenience of input color data correction, the present invention converts the format of the input color data to LCh (lightness, chroma and hue) format. Thus the first conversion unit 80 in this embodiment is used to convert the input color data in RGB format or other format to LCh format. Then the converted input color data is sent to the correction unit 30. The second conversion unit 90 converts the adjusted color data to the output format of the output unit 40. Furthermore, the format of the color characteristic data of the color output device and the reference device sent to the segmentation unit 10 are LCh (lightness, chroma and hue) format. After being measured by measuring instrument, the color characteristic data are also converted into the LCh format.

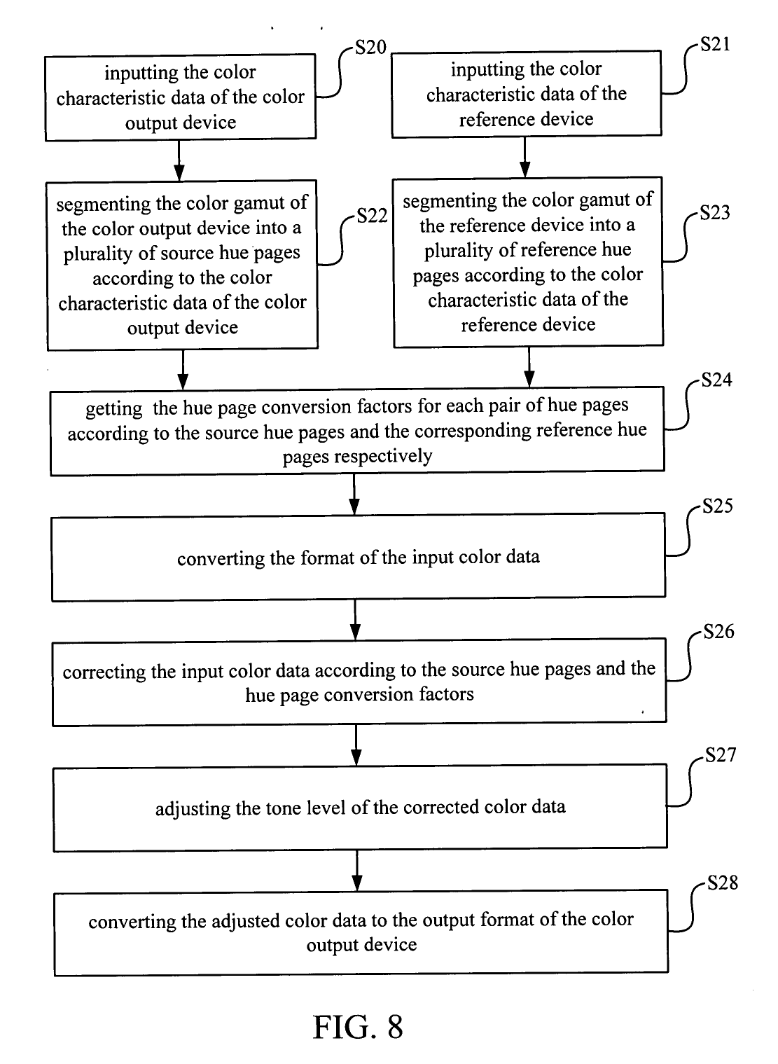

Refer to FIG. 8, firstly see step S20 and S21, input the color characteristic data of the color output device and the reference device to the segmentation unit 10. Then, see step S22 and S23, segment the color gamut of the color output device and the color gamut of the reference device respectively into a plurality of source hue pages and a plurality of reference hue pages by the segmentation unit 10 according to the color characteristic data of the color output device and the reference device. Then run the step S24 by the processing unit 20, get a hue page conversion factor for each pair of hue pages according to the source hue pages and the reference hue pages that correspond to each other. Next, take step S25, convert the format of the input color data to LCh (lightness, chroma and hue) format by the first conversion unit 80 and send the coverted input color data to the correction unit 30.

The correction unit 30 runs step S26, checks location of the input color data according to the source hue pages and corrects the input color data according to hue page conversion factors of two neighboring source hue pages. The corrected color data is sent to the tone adjustment unit 70. Then take the step S27 by the tone adjustment unit 70, adjust the tone level of the corrected color data and then send the adjusted color data to the second conversion unit 90. Finally, run the step S28, the second conversion unit 90 converts the adjusted color data to the output format of the output unit 40 of the color output device and sends the converted color data to the output unit 40 for display colors. While executing the step S23, the segmentation unit 10 can also segment the color gamut of the color output device into a plurality of reference hue pages according to the color characteristic data of the reference device.

In summary, a hue correction system of the present invention includes a segmentation unit, a processing unit, and a correction unit. A hue correction method according to the present invention firstly uses the segmentation unit to segment color gamut of the color output device and color gamut of the reference device into a plurality of source hue pages and a plurality of reference hue pages respectively according to a plurality of color characteristic data of the color output device and the reference device. Or only the color gamut of the color output device is segmented into a plurality of source hue pages and a plurality of reference hue pages. Then the processing unit calculates hue page conversion factors according to the source hue pages and the reference hue pages that correspond to each other. At last, the correction unit corrects input color data according to the source hue pages and the hue page conversion factors and the corrected color data is output for display. Therefore, color quality representation on the color output device is improved.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A hue correction system comprising:
a segmentation unit for segmenting the color gamut of a color output device into a plurality of source hue pages according to its color characteristic data and segmenting the color gamut of a reference device into a plurality of reference hue pages according to the color characteristic data of the reference device, wherein the source hue pages and the reference hue pages correspond to each other;
a processing unit for calculating to get a plurality of hue page conversion factors according to the source hue pages and the reference hue pages corresponding to each other, wherein each of the hue page conversion factor corresponds to the source hue page and the reference hue page correspond to each other; and
a correction unit for correcting an input color data being fed into the color output device according to the source hue pages and the hue page conversion factors.

2. The system as claimed in claim 1, wherein the processing unit is adapted to get the hue page conversion factors according to the hue angles of the source hue pages and the reference hue pages.

3. The system as claimed in claim 1, wherein the processing unit is adapted to get the hue page conversion factors according to the areas of the source hue pages and the reference hue pages.

4. The system as claimed in claim 1, wherein the hue page conversion factor is a transformation matrix.

5. The system as claimed in claim 4, wherein the transformation matrix is a n×m matrix, wherein n and m are greater than or equal to 3.

6. The system as claimed in claim 1, wherein the correction unit is adapted to correct the input color data according to the hue page conversion factor of the source hue page corresponding to the input color data.

7. The system as claimed in claim 1, wherein the correction unit is adapted to correct the input color data according to a correction factor calculated from the hue page conversion factors of two neighboring source hue pages that the input color data locates in-between.

8. The system as claimed in claim 7, wherein the correction unit is adapted to calculate the correction factor according to the hue angle differences between the input color data and the two neighboring source hue pages respectively.

9. The system as claimed in claim 1, the system further comprising:
a first conversion unit for converting the input color data to a format for correction and sending the converted color data into the correction unit; and
a second conversion unit for converting the color data corrected by the correction unit to the output format of the color output device.

10. The system as claimed in claim 9, wherein the first conversion unit converts the input color data into a LCh (lightness, chroma, and hue) format.

11. The system as claimed in claim 1, the system further comprising a tone adjustment unit for adjusting tone level of the color data corrected by the correction unit.

12. The system as claimed in claim 1, wherein the color output device and the reference device include monitors, projectors, or color printers.

13. A hue correction method comprising the steps of:
segmenting the color gamut of a color output device into a plurality of source hue pages according to its color characteristic data and segmenting the color gamut of a reference device into a plurality of reference hue pages according to the color characteristic data of the reference device, wherein the source hue pages and the reference hue pages correspond to each other;
getting a plurality of hue page conversion factors according to the source hue pages and the reference hue pages corresponding to each other, wherein each of the hue page conversion factor corresponds to the source hue page and the reference hue page correspond to each other; and
correcting an input color data being fed into the color output device according to the source hue pages and the hue page conversion factors.

14. The method as claimed in claim 13, wherein in the step of getting the hue page conversion factors, the hue page conversion factors are got according to the hue angles of the source hue pages and the reference hue pages.

15. The method as claimed in claim 13, wherein in the step of getting the hue page conversion factors, the hue page conversion factors are got according to the areas of the source hue pages and the reference hue pages.

16. The method as claimed in claim 13, wherein the hue page conversion factor is a transformation matrix.

17. The method as claimed in claim 16 wherein the transformation matrix is a n×m matrix, wherein n and m are greater than or equal to 3.

18. The method as claimed in claim 13, wherein in the step of correcting the input color data, the input color data is corrected according to the hue page conversion factor of the source hue page corresponding to the input color data.

19. The method as claimed in claim 13, wherein in the step of correcting the input color data, the input color data is corrected according to a correction factor calculated from the hue page conversion factors of two neighboring source hue pages that the input color data locates in-between.

20. The method as claimed in claim 19, wherein in the step of getting the correction factor according to the hue angles differences between the input color data and the two neighboring source hue pages respectively.

21. The method as claimed in claim 13, wherein in the step of correcting the input color data, the step further comprising steps of:
converting the input color data to a format for correcting the input color data; and
converting the color data that has been corrected to the output format of the color output device.

22. The method as claimed in claim 21, wherein the step of converting the input color data is converting the input color data into a LCh (lightness, chroma, and hue) format.

23. The method as claimed in claim 13, wherein after the step of correcting the input color data, further comprising a step of: adjusting tone level of the color data that has been corrected.

24. The method as claimed in claim 13, wherein the color output device and the reference device include monitors, projectors, or color printers.
